(19) United States
(12) Patent Application Publication
(10) Pub. No.: US 2020/0011357 A1
(43) Pub. Date: Jan. 9, 2020

(54) FIXING TOOL

(71) Applicants: AutoNetworks Technologies, Ltd., Yokkaichi, Mie (JP); Sumitomo Wiring Systems, Ltd., Yokkaichi, Mie (JP); Sumitomo Electric Industries, Ltd., Osaka-Shi (JP)

(72) Inventors: Yuuya Fukami, Yokkaichi, Mie (JP); Shinya Itou, Yokkaichi, Mie (JP)

(21) Appl. No.: 16/491,608

(22) PCT Filed: Feb. 21, 2018
(86) PCT No.: PCT/JP2018/006180

§ 371 Date: Sep. 6, 2019

(30) Foreign Application Priority Data
Mar. 9, 2017 (JP) 2017-045002

(51) Int. Cl. F16B 2/08; H02G 3/30; B60R 16/02

(52) U.S. Cl. CPC F16B 2/08; B60R 16/0207; H02G 3/30

(57) ABSTRACT

Provided is a fixing tool that can fix and route metal wiring on a fixing target in multiple types of forms. A fixing tool for fixing plate-shaped metal wiring to a fixing target in a vehicle in routing of the metal wiring includes: a fixing member to be fixed to the fixing target; and a holding member for holding the metal wiring, provided separately from the fixing member. The holding member includes a mounting portion to which the fixing member is to be mounted and a band portion that is to be wrapped around and hold the metal wiring. The fixing member includes a fixing portion to be fixed to the fixing target and a portion to be mounted to the mounting portion.

### CROSS-REFERENCE TO RELATED APPLICATIONS

This application is the U.S. national stage of PCT/JP2018/006180 filed on Feb. 21, 2018, which claims priority of Japanese Patent Application No. JP 2017-045002 filed on Mar. 9, 2017, the contents of which are incorporated herein.

### TECHNICAL FIELD

This disclosure relates to a fixing tool for fixing plate-shaped metal wiring to a fixing target in a vehicle in routing of the metal wiring.

### BACKGROUND

JP 2016-120901A discloses an automobile power supply device for supplying electric power to parts of a vehicle using plate-shaped metal wiring that is routed from a battery installed in an engine room of a vehicle body to a vehicle interior.

JP 2016-120901A also discloses a technique for fixing a holding portion that is for holding the plate-shaped metal wiring to a vehicle body, which is a fixing target, by fastening using a screw.

However, in fastening using a screw, the screw penetrates the vehicle body, which is the fixing target, and thus a technique other than fastening using a screw (for example, a technique such as metal welding) needs to be used for fixing at a position in the vehicle body where penetration with a screw is not acceptable. As described above, the specific form of fixing the plate-shaped metal wiring to the fixing target varies according to the position and the shape of the fixing target.

With the foregoing in mind, it is an object of the present disclosure to provide a fixing tool that can fix metal wiring to a fixing target in multiple types of forms according to the position and the shape of the fixing target.

### SUMMARY

In order to solve the above-described problem, a fixing tool for fixing plate-shaped metal wiring to a fixing target in a vehicle in routing of the metal wiring includes: a fixing member to be fixed to the fixing target; and a holding member for holding the metal wiring, provided separately from the fixing member. The holding member includes a mounting portion to which the fixing member is to be mounted and a band portion that is to be wrapped around and hold the metal wiring. The fixing member includes a fixing portion to be fixed to the fixing target and a portion to be mounted to the mounting portion.

### Advantageous Effects of Disclosure

By using the fixing tool according to the present disclosure, it is possible to fix metal wiring to a fixing target in multiple types of forms according to the position and the shape of the fixing target.

### BRIEF DESCRIPTION OF DRAWINGS

FIG. 1 is a perspective view schematically showing an example of a configuration of metal wiring.

FIG. 2 schematically shows an example of a routing form of metal wiring inside a vehicle.

FIG. 3 is a perspective view schematically showing a configuration of a fixing tool.

FIG. 4 is a perspective view schematically showing a state where the metal wiring is held using the fixing tool.

FIG. 5 is a cross-sectional view taken along line V-V in FIG. 4.

FIG. 6 is an enlarged cross-sectional view taken along line VI-VI in FIG. 4.

FIG. 7 is a cross-sectional view showing a state where the metal wiring is fixed to a fixing target using the fixing tool.

FIG. 8 is a perspective view schematically showing a configuration of a fixing member.

FIG. 9 is a cross-sectional view showing a state where the metal wiring is fixed to a fixing target using a fixing tool.

FIG. 10 is a perspective view schematically showing a configuration of another fixing member.

FIG. 11 is a cross-sectional view showing a state where the metal wiring is fixed to a fixing target using another fixing tool.

FIG. 12 is a perspective view schematically showing a configuration of still another fixing member.

FIG. 13 is a cross-sectional view showing a state where the metal wiring is fixed to a fixing target using still another fixing tool.

### DETAILED DESCRIPTION OF PREFERRED EMBODIMENTS

### Overall Configuration

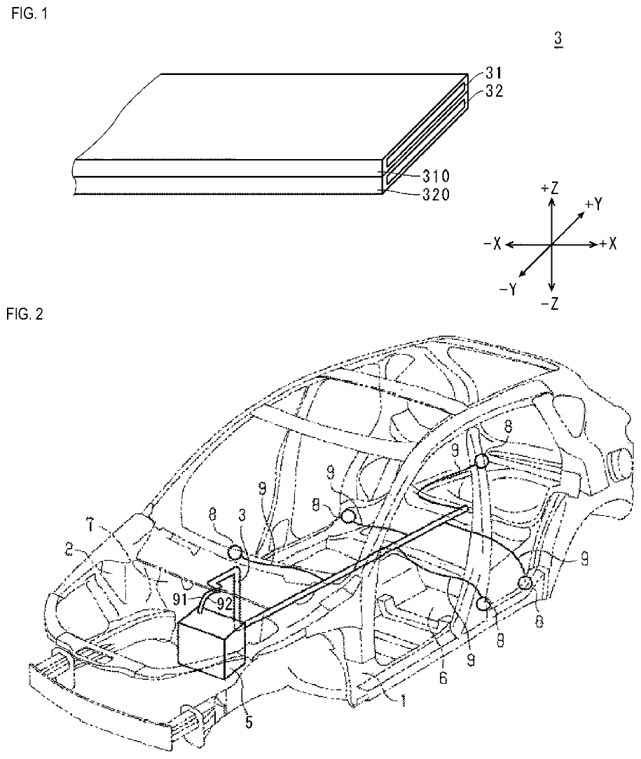

FIG. 1 is a perspective view schematically showing an example of the configuration of metal wiring 3. In FIG. 1 and each of the subsequent drawings, XYZ orthogonal coordinate axes are shown where necessary for the purpose of clarifying the directional relationship.

The metal wiring 3 includes conductor plates 31 and 32 and insulating coatings 310 and 320 that surround the conductor plates 31 and 32, respectively. The metal wiring 3 is mounted on a vehicle as described below.

The conductor plate 31 has an elongated shape that extends in the longitudinal direction (employed as ±X directions in FIG. 1), and the cross section thereof perpendicular to the longitudinal direction (employed as a YZ cross section in FIG. 1, and this cross section is hereinafter also referred to as “module cross section”) has a flat shape. For example, the conductor plate 31 may have a rectangular module cross section. The dimension of the conductor plate 31 in the thickness direction (employed as ±Z directions in FIG. 1) (hereinafter simply referred to as “thickness”) may be set as appropriate, and for example, can be set to between 0.5 [mm] and 1 [mm] inclusive. The dimension of the conductor plate 31 along the width direction (the direction perpendicular to the longitudinal direction and the thickness direction: employed as ±Y directions in FIG. 1) (hereinafter simply referred to as “width”) may also be set as appropriate, and for example, can be set to between 50 [mm] and 100 [mm] inclusive.

The conductor plate 31 is made of a conductive material. For example, metal such as copper, a copper alloy, aluminum, or an aluminum alloy can be employed as the material of the conductive plate 31. The conductor plate 31 can function as wiring as described below.

Examples of the shape, size, and material of the conductor plate 32 are similar to those described above for the conductor plate 31, and thus descriptions thereof will not be repeated. This conductor plate 32 can also function as wiring as described below.

The conductor plates 31 and 32 are disposed so as to face each other while being spaced apart from each other in the thickness direction. The conductor plates 31 and 32 extend in the same direction, and their longitudinal directions, thickness directions, and width directions are substantially the same.

The insulating coating 310 covers the periphery (entire periphery) of the conductor plate 31 at least in the module cross section. Similarly, the insulating coating 320 covers the periphery (entire periphery) of the conductor plate 32 at least in the module cross section. Now, the insulating coatings 310 and 320 will be described with reference to an upper surface, a lower surface, and side surfaces of each of the conductor plates 31 and 32. The upper surface is a surface located on one side (+Z side) in the thickness direction, and the lower surface is a surface located on the other side (−Z side) in the thickness direction. The side surfaces are located on both sides (±Y sides) in the width direction and couple the upper surface and the lower surface. Accordingly, the insulating coating 310 covers the upper surface, the lower surface, and both side surfaces of the conductor plate 31. The insulating coating 320 covers the upper surface, the lower surface, and both side surfaces of the conductor plate 32. The conductor plates 31 and 32 are stacked in the thickness direction (Z-axis direction) in such a manner that the lower surface of the insulating coating 310 is in contact with the upper surface of insulating coating 320.

These insulating coatings 310 and 320 are made of an insulating material. The material of the insulating coatings 310 and 320 may be selected as appropriate. For example, a resin can be employed as the material of the insulating coatings 310 and 320.

These insulating coatings 310 and 320 can ensure insulation of the conductor plates 31 and 32 from the outside in a state where insulation between the conductor plates 31 and 32 is ensured.

FIG. 2 schematically shows an example of the routing form of the metal wiring 3 inside a vehicle. In the example shown in FIG. 2, an example of a vehicle body (a so-called “body”) 4 of the vehicle is indicated by a two-dot dash line.

The metal wiring 3 is routed inside the vehicle in a state where insulation of the metal wiring 3 from the vehicle body 4 is ensured. Specifically, the metal wiring 3 is provided so as to extend to a vehicle interior 6 through a partition wall 7 that demarcates the boundary between an engine room 2 and the vehicle interior 6. Then, the metal wiring 3 extends downward along the partition wall 7 in the vehicle interior 6, and further extends along a central portion on a floor surface of the vehicle interior 6 toward the rear side of the vehicle body 4. Multiple loads 8 installed in the vehicle body 4 are connected to portions of the metal wiring 3 closest to the respective loads 8 via respective electric wires 9.

A power storage device 5 is installed in the engine room 2 of the vehicle body 4 of an automobile. The power storage device 5 is a battery (e.g., a lead battery or a lithium ion battery) or a capacitor, for example. The power storage device 5 includes a low potential (negative) side output terminal and a high potential (positive) side output terminal, and outputs a DC voltage between the output terminals. The power storage device 5 may also be disposed in a portion in the vehicle other than the engine room 2.

The conductor plate 31 is electrically connected to the low potential side output terminal of the power storage device 5 via an electric wire 91, for example. That is, one end of the electric wire 91 is connected to the low potential side output terminal of the power storage device 5, and the other end of the electric wire 91 is connected to the conductor plate 31. The electric wire 91 and the conductor plate 31 may be connected to each other using any appropriate method. For example, a part of the insulating coating 310 is removed to expose a part of the conductor plate 31, and a conductor portion (e.g., a core wire or a terminal) at one end of the electric wire 91 is fixed to the conductor plate 31 in the state of being in contact with the exposed part of the conductor plate 31. The fixing may be performed using any appropriate method. For example, a fixing method using a screw, solder, or conductive adhesive can be employed.

The conductor plate 32 is electrically connected to the high potential side output terminal of the power storage device 5 via an electric wire 92, for example. That is, one end of the electric wire 92 is connected to the high potential side output terminal of the power storage device 5, and the other end is connected to the conductor plate 32. The connection between the conductor plate 32 and the electric wire 92 is similar to the connection between the conductor plate 31 and the electric wire 91, and thus a description thereof will not be repeated.

One ends of the respective electric wires 9 are connected to the metal wiring 3 at predetermined positions in the longitudinal direction. The connection between the conductor plates 31 and 32 of the metal wiring 3 and the respective electric wires 9 is similar to the connection between the conductor plate 31 and the electric wire 91, and thus a description thereof will not be repeated. The other ends of the respective electric wires 9 are connected to the respective loads 8. The load 8 may be, for example, an electronic control unit (ECU) that includes a control circuit or an electrical appliance such as an electric motor.

In the power supply system configured as above, electric power from the power storage device 5 is supplied to the loads 8 via the electric wires 91 and 92, the conductor plates 31 and 32, and the electric wires 9. That is, the conductor plates 31 and 32 can function as wiring. Also, in the example shown in FIG. 2, the electric wires 91 and 92 and the electric wires 9 can be regarded as a wire harness, and accordingly, the metal wiring 3 also functions as a connection module for connection of the wire harness.

In this metal wiring 3, the conductor plates 31 and 32 face each other in the thickness direction as described above. This can effectively reduce the noise generated by currents flowing through the conductor plates 31 and 32. Specifically, the direction in which a current flows through the conductor plate 31 is opposite to the direction in which a current flows through the conductor plate 32, and accordingly, magnetic fluxes generated by the currents cancel each other out. As a result, electromagnetic noise can be reduced.

Moreover, in this metal wiring 3, the peripheries of the conductor plates 31 and 32 are covered with the insulation coatings 310 and 320, respectively, and thus it is possible to ensure insulation of the conductor plates 31 and 32 from the outside. Therefore, even if a conductive member is disposed in the vicinity of the conductor plates 31 and 32, current leakage from the conductor plates 31 and 32 to the conductive member can be suppressed. Therefore, an increase in power consumption can be suppressed.

Although FIG. 2 shows an example where one power storage device 5 is provided, multiple power storage devices 5 may be provided. In this case, the output terminals of the multiple power storage devices 5 may each be connected to the conductor plates 31 and 32.

### Configuration of Fixing Tool 1

Next, a fixing tool 1 for fixing and routing the plate-shaped metal wiring 3 on a fixing target will be described.

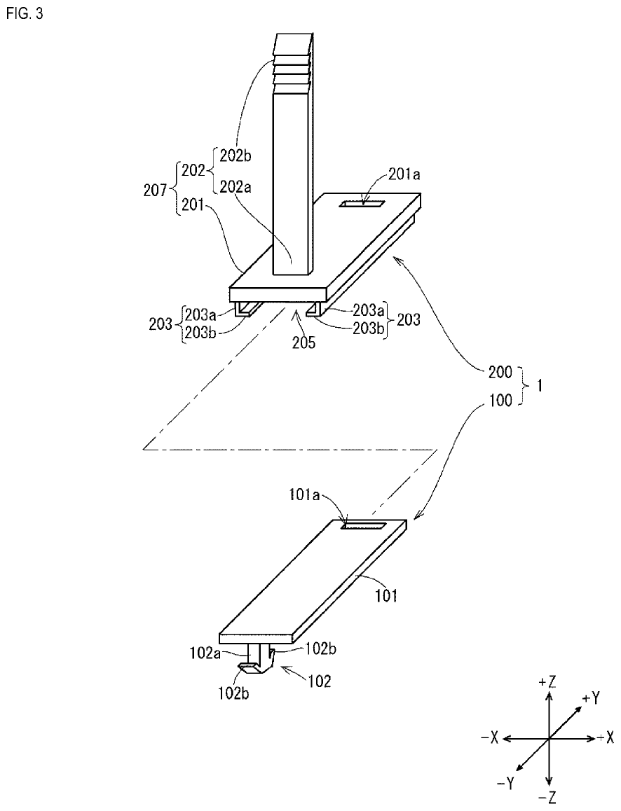

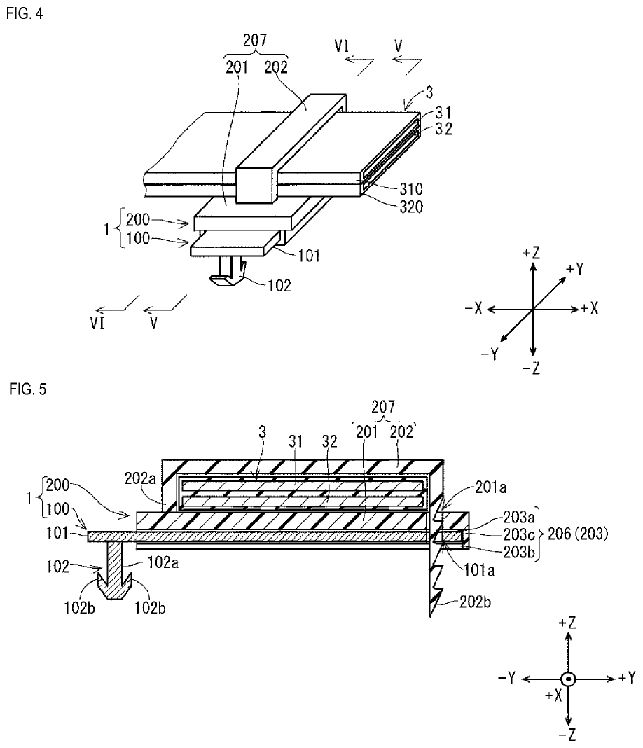

FIG. 3 is a perspective view schematically showing the configuration of a fixing member 100 and a holding member 200, which constitute the fixing tool 1. FIG. 4 is a perspective view schematically showing a state where the metal wiring 3 is held using the fixing tool 1. The fixing member 100 and the holding member 200 are provided separately, and the fixing member 100 is mounted to a mounting portion 203 of the holding member 200 following a virtual line indicated by a dot dash line shown in FIG. 3. This mounting operation will be described in detail below.

The fixing tool 1 includes the fixing member 100 to be fixed to a fixing target 10 (e.g., the vehicle body 4), and the holding member 200 provided separately from the fixing member 100.

As shown in FIG. 3, the fixing member 100 includes a plate-shaped base portion 101 and an anchor portion 102 (a so-called clamp) that protrudes from a principal surface of the base portion 101.

On one side (+Y side) of the base portion 101 in the longitudinal direction, a hole 101a is provided penetrating the base portion 101 in the normal direction (Z-axis direction) of the principal surfaces of the base portion 101. The hole 101a is a through-hole for allowing a later-described belt portion 202 to pass therethrough.

On the other side (−Y side) of the base portion 101 in the longitudinal direction, the anchor portion 102 that protrudes from the principal surface of the base portion 101 toward the −Z side along the normal direction of the base portion 101 is provided. The anchor portion 102 is a portion for fixing the fixing member 100 to a fixing target in a vehicle.

In this example, the anchor portion 102 includes a column portion 102a and locking portions 102b. The column portion 102a is formed in a columnar shape that extends in the above-described normal direction, and is configured such that it can pass through a hole 10a of the fixing target 10. The locking portions 102b are provided at an end portion on the far side from the base portion 101 (hereinafter referred to as “leading end portion”) of the column portion 102a, with a larger diameter than the column portion 102a. The column portion 102a is configured so as to be able to lock with a peripheral edge portion of the hole 10a in a state where the column portion 102a is inserted into the hole 10a of the fixing target 10. More specifically, the pair of locking portions 102b are provided so as to expand outward from the leading end portion of the column portion 102a toward the base portion 101. The pair of locking portions 102b are formed so as to be elastically deformable inward and outward. When the anchor portion 102 is pushed into the hole 10a of the fixing target 10, outer surfaces of the pair of locking portions 102b are brought into contact with an inner peripheral edge portion of the hole 10a of the fixing target 10 and elastically deform inward. Then, when the anchor portion 102 is inserted into the hole 10a of the fixing target 10 to the extent that the pair of locking portions 102b have moved past the inner peripheral edge portion of the hole 10a of the fixing target 10, the pair of locking portions 102b return to their original shapes owing to their restoring force. As a result, the pair of locking portions 102b are locked with the peripheral edge portion of the hole 10a of the fixing target 10, whereby the fixing member 100 is fixed to the fixing target 10. The fixing member 100 is a component obtained by, for example, integrally molding the base portion 101 and the anchor portion 102 using a resin.

As shown in FIG. 3, the holding member 200 includes a plate-shaped base portion 201, a belt portion 202 for holding/retaining the metal wiring 3 together with the base portion 201, and the mounting portion 203 that is coupled to the base portion 201 and to which the fixing member 100 can be mounted.

On one side (+Y side) of the base portion 201, a hole 201a is provided penetrating the base portion 201 in the normal direction (Z-axis direction). The hole 201a is a through-hole for allowing the later-described belt portion 202 to pass therethrough.

On the other side (−Y side) of the base portion 201 in the longitudinal direction, the band portion 202 is provided. One end (referred to as “end portion 202a”) of the band portion 202 is fixed to a principal surface of the base portion 201 on one side (+Z side), and the other end (referred to as “end portion 202b”) of the band portion 202 on the side opposite to the end portion 202a is a free end. That is, the band portion 202 is a portion that extends from the principal surface of the base portion 201 on one side (+Z side) thereof.

The mounting portion 203 has a pair of first walls 203a and a pair of second walls 203b. The pair of first walls 203a prevent the movement of the fixing member 100 along the X-axis direction (as described below, the direction in which the metal wiring 3 extends when the metal wiring 3 is held using the fixing tool 1). The pair of second walls 203b prevent the movement of the fixing member 100 along the direction (−Z direction) away from the base portion 201.

The pair of first walls 203a are two walls that are provided along the X-axis direction with a certain distance between them and extend along a plane (YZ plane) perpendicular to the X-axis direction. This distance is slightly larger than the length in the X-direction of the fixing member 100 to be mounted to the mounting portion 203. End portions of the pair of first walls 203a on one side (+Z side) are fixed to, out of both principal surfaces of the base portion 201, the principal surface (−Z-side principal surface) on the opposite side to the side on which the band portion 202 is provided. From end portions of the pair of first walls 203a on the other side (−Z side), the pair of second walls 203b extend along the plane (XY plane) perpendicular to the Z-axis direction in the direction in which the second walls 203b approach each other. The distance between the pair of second walls 203b and the base portion 201 along the Z-axis direction is slightly larger than the thickness in the Z direction of the fixing member 100 to be mounted to the mounting portion 203.

Accordingly, the mounting portion 203 can house the fixing member 100 in a housing space 205 surrounded by the base portion 201, the pair of first walls 203a, and the pair of second walls 203b, and can position the fixing member 100 along the X-axis direction and the Z-axis direction.

FIG. 5 is a cross-sectional view taken along line V-V in FIG. 4. As shown in FIG. 5, the ends of the pair of first walls 203a and the pair of second walls 203b on the −Y side are open, whereas the ends of the pair of first walls 203a and the pair of second walls 203b on the +Y side are closed by a third wall 203c.

Accordingly, by inserting the base portion 101 kept in parallel to the base portion 201 in the +Y direction via the above-described open ends, the base portion 101 can be housed in the housing space 205. Then, by abutting the +Y-side end of the base portion 101 abuts against the inner wall of the third wall 203c, the fixing member 100 can be positioned with respect to the mounting portion 203 along the Y-axis direction.

As described above, the pair of first walls 203a, the pair of second walls 203b, and the third wall 203c function as a frame portion 206 (see FIG. 5) for guiding the fixing member 100 in the first direction (+Y direction) and positioning the fixing member 100 in the three orthogonal directions. The state where the fixing member 100 has been positioned by the mounting portion 203 is hereinafter referred to as a mounted state.

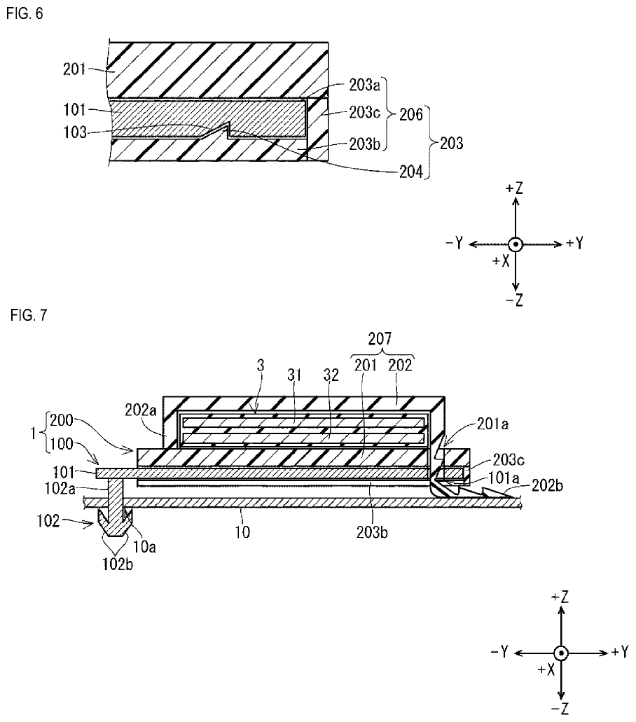

FIG. 6 is an enlarged view showing a portion in the vicinity of the third wall 203c in the cross section taken along line VI-VI in FIG. 4. As shown in FIG. 6, the mounting portion 203 may further include latch mechanisms 204 in addition to the frame portion 206. The latch mechanisms 204 allow movement of the fixing member 100 in the first direction and prevent movement of the fixing member 100 in the second direction (−Y direction) opposite to the first direction. With this configuration, the fixing member 100 can be mounted to the mounting portion 203, and detachment of the fixing member 100 from the frame portion 206 is inhibited once the mounted state is established. As described above, the frame portion 206 is a portion for guiding the mounting of the fixing member 100, and the latch mechanisms 204 are portions for restricting the mounting of the fixing member 100 guided by the frame portion 206.

More specifically, the latch mechanisms 204 are locking protrusions that are formed so as to protrude from the +Z-side principal surfaces of the pair of second walls 203b toward the +Z side with the amount of protrusion increasing gradually toward the +Y side. On the −Z-side principal surface of the base portion 101, recesses 103 with which the latch mechanisms 204 engage are formed at positions opposing the latch mechanisms 204 in the mounted state in such a manner that the depth thereof increases gradually toward the +Y side.

Accordingly, in the process of inserting the fixing member 100 into the housing space 205 of the mounting portion 203, the latch mechanisms 204 elastically deform in the direction in which the protrusion amount thereof decreases. Then, when the fixing member 100 is inserted into the housing space 205 to the extent that the +Y-side end of the base portion 101 abuts against the third wall 203c, the latch mechanisms 204 return to their original protruding shape owing to their restoring force, and the state where the latch mechanisms 204 are fitted in the recesses 103 is maintained. As a result, the mounted state where the fixing member 100 is fixed to the holding member 200 is obtained. As described above, the base portion 101 of the fixing member 100 functions as a portion to be mounted to the mounting portion 203.

The hole 101a of the base portion 101 and the hole 201a of the base portion 201 have substantially the same opening area, and in the mounted state, the hole 101a of the base portion 101 and the hole 201a of the base portion 201 are aligned with each other in an XY plan view. That is, the hole 101a of the base portion 101 is in communication with the hole 201a of the base portion 201 in the mounted state. Furthermore, the area of the cross section of the belt portion 202 orthogonal to the extending direction is substantially the same as or smaller than the above-described opening area. Accordingly, the end portion 202b of the belt portion 202 can pass through the holes 101a and 201a.

Therefore, as shown in FIGS. 4 and 5, the metal wiring 3, the fixing member 100, and the holding member 200 are integrated by bringing the +Z-side principal surface of the base portion 201 into contact with the −Z-side principal surface of the metal wire 3 and passing the end portion 202b of the belt portion 202 through the holes 101a and 201a with the belt portion 202 being in contact with the +Z-side principal surface of the metal wire 3.

The end portion 202b of the base 202 has multiple inclined portions each of which increases in thickness from the leading end side, which is on the opposite side to the base portion 201, toward the base portion 201 along the extending direction, and thus the end portion 202b has a multi-step shape. Therefore, the thick portion of one of the inclined portion locks with the hole 201a of the base portion 201, and thus a state where the metal wire 3, the fixing member 100, and the holding member 200 are integrated can be maintained. In addition, by passing the belt portion 202 through the holes 101a and 201a, the fixing member 100 is positioned with high accuracy with respect to the holding member 200. As described above, the base portion 201 is a portion to which the metal wiring 3 is to be mounted, and the holes 101a and 201a are portions for fixing the end portion 202b of the belt portion 202. As a result of fixing the end portion 202b of the belt portion 202 using the holes 101a and 201a, the base portion 201 and the belt portion 202 are wrapped around and can hold the metal wiring 3 in a state where it extends along the X-axis direction. As described above, the base portion 201, the hole 201a, and the belt portion 202 function as a band portion 207 that is to fix the metal wiring 3 by being wrapped around and holding the metal wiring 3.

FIG. 7 is a cross-sectional view showing a state where the metal wiring 3 is fixed to the fixing target 10 using the fixing tool 1. The metal wiring 3 can be fixed to and routed on the fixing target 10 as shown in FIG. 7 by passing, through the hole 10a of the fixing target 10, the anchor portion 102 of the fixing member 100, which is included in the above-described integrated body constituted by the metal wiring 3, the fixing member 100, and the holding member 200. As described above, the anchor portion 102 functions as a fixing portion to be fixed to the fixing target 10. In the example shown in FIG. 7, the end portion 202b of the belt portion 202 is guided by the fixing target 10 so as to extend to the +Y side, but, when the metal wiring 3 is to be fixed to the fixing target 10, if a case occurs where the end portion 202b of the belt portion 202 is to be a hindrance, the end portion 202b may be removed (e.g., cut off) prior to the fixing being carried out.

Variations of Fixing member

Next, fixing tools 1A to 1C that use fixing members 100A to 100C, respectively, instead of the above-described fixing member 100 will be described. In the following, components/portions common between the fixing members 100A to 100C and the fixing member 100 and components/portions common between the fixing tools 1A to 1C and the fixing tool 1 are given the same reference numerals, and descriptions thereof will not be repeated.

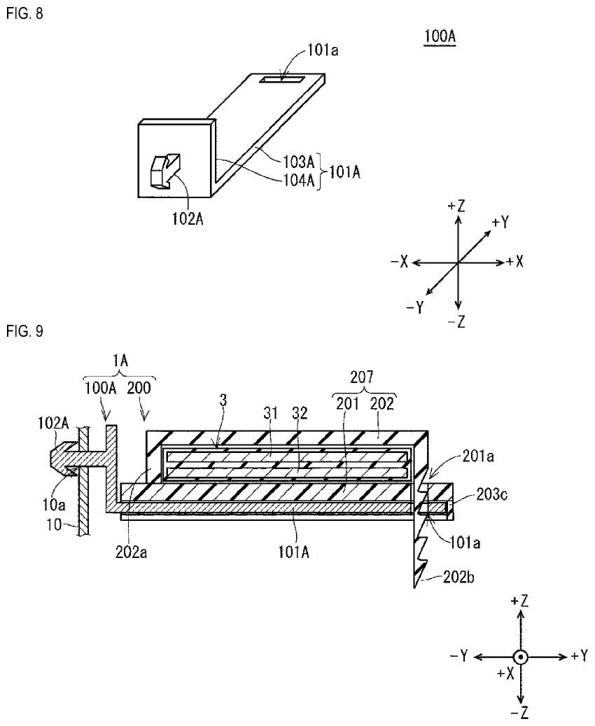

FIG. 8 is a perspective view schematically showing the configuration of the fixing member 100A. The fixing member 100A includes a base portion 101A and an anchor portion 102A. The base portion 101A includes a first base portion 103A and a second base portion 104A. The first base portion 103A is provided with a hole 101a, and the second base portion 104A is provided with the anchor portion 102A. The anchor portion 102A has a function similar to that of the anchor portion 102. Specifically, the first base portion 103A is orthogonally coupled to the second base portion 104A, and the anchor portion 102A and the first base portion 103A are located on sides opposite to each other with respect to the second base portion 104A. When this configuration is expressed using XYZ coordinates, the first base portion 103A extends in an XY plane orthogonal to the Z-axis direction, the second base portion 104A extends in an XZ plane orthogonal to the Y-axis direction, and the edge of the first base portion 103A on the −Y direction side is coupled with the edge of the second base portion 104A on the −Z direction side. The anchor portion 102A is provided so as to extend in the −Y direction from the second base portion 104A.

FIG. 9 is a cross-sectional view showing a state where metal wiring 3 is fixed to a fixing target 10 using the fixing tool 1A. The metal wiring 3 can be fixed to and routed on the fixing target 10 as shown in FIG. 9 by passing, through a hole 10a of the fixing target 10, the anchor portion 102A of the fixing member 100A, which is included in the integrated body constituted by the metal wiring 3, the fixing member 100A, and a holding member 200.

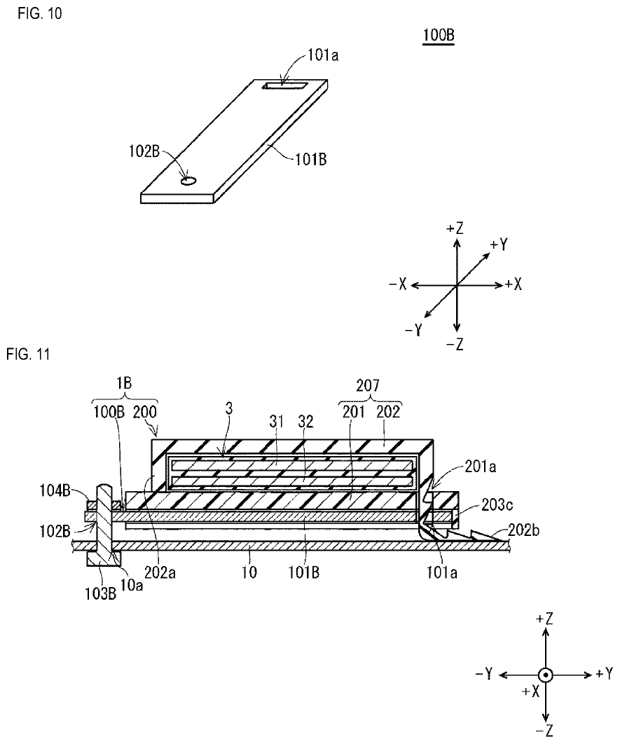

FIG. 10 is a perspective view schematically showing the configuration of the fixing member 100B. The fixing member 100B includes a plate-shaped base portion 101B, a hole 101a that is provided on one side of the base portion 101B so as to penetrate the base portion 101B in the normal direction of its principal surfaces and a hole 102B that is provided on the other side of the base portion 101B so as to penetrate the base portion 101B in the normal direction of its principal surfaces. When this configuration is expressed using XYZ coordinates, the base portion 101B extends along an XY plane orthogonal to the Z-axis direction, and on the opposite side (−Y side) to the hole 101a along the XY plane, the hole 102B that penetrates the base portion 101B in the Z-axis direction is provided. The hole 102B is a hole for allowing a later-described bolt 103B to pass therethrough.

FIG. 11 is a cross-sectional view showing a state where metal wiring 3 is fixed to a fixing target 10 using the fixing tool 1B. The fixing tool 1B further includes, as a structure for fixing the metal wiring 3 to the fixing target 10, a bolt 103B that is provided so as to protrude from the outside to the inside of a vehicle body 4 with respect to the fixing target 10 and a nut 104B having an inner circumferential surface that can be threaded onto the bolt 103B.

With this configuration, the metal wiring 3 can be fixed to and routed on the fixing target 10 as shown in FIG. 11 by passing the bolt 103B through the hole 102B of the fixing member 100B, which is included in the integrated body constituted by the metal wiring 3, the fixing member 100B, and a holding member 200, from the vehicle body 4 side (−Z side) and then screwing the nut 104B onto the bolt 103B from the vehicle interior side (−Z side).

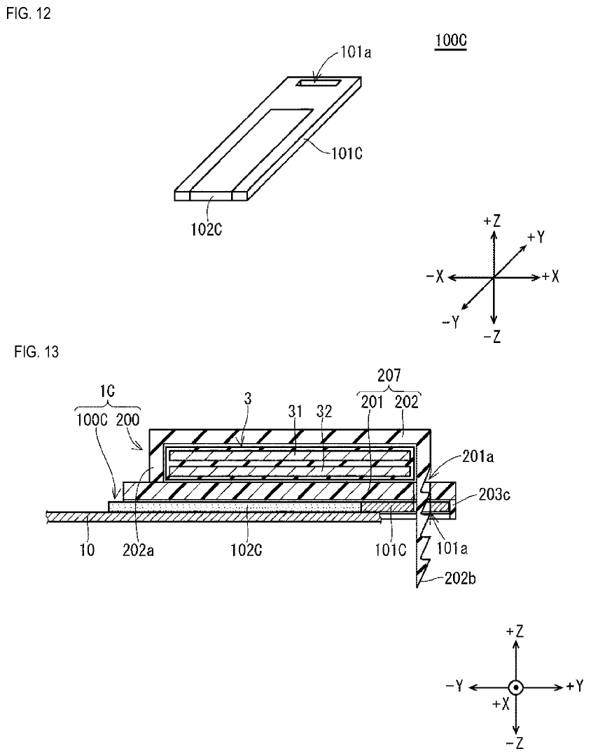

FIG. 12 is a perspective view schematically showing the configuration of the fixing member 100C. The fixing member 100C includes a base portion 101C and a metal portion 102C. The base portion 101C has a plate shape, and is formed in a U-shape as viewed in the normal direction of its principal surfaces. The metal portion 102C is a plate-shaped portion configured such that both principal surfaces thereof are flush with both principal surfaces of the base portion 101C, and is provided in a space surrounded by the U-shaped base portion 101C. When this configuration is expressed using XYZ coordinates, the base portion 101C extends in a U-shape along an XY plane orthogonal to the Z-axis direction, and the metal portion 102C is provided on the opposite side (−Y side) to the hole 101a along the XY plane so as to be placed in the space surrounded by the U-shaped base portion 101C. The metal portion 102C is a portion to be melted in a welding process to be described below.

FIG. 13 is a cross-sectional view showing a state where metal wiring 3 is fixed to a fixing target 10 using the fixing tool 1C. A welding process is performed by melting the metal portion 102C of the fixing member 100C, which is included in the integrated body constituted by the metal wiring 3, the fixing member 100C, and a holding member 200, and bringing the melted portion into contact with the fixing target 10. In this manner, the metal wiring 3 can be fixed to and routed on the fixing target 10 as shown in FIG. 13.

As described above, in the present embodiment, the holding member 200 is provided separately from the fixing members 100 and 100A to 100C. Accordingly, the holding member 200 is compatible with the multiple types of fixing members 100 and 100A to 100C as long as the fixing members 100 and 100A to 100C can be mounted using the mounting portion 203. As a result, in the case where the plate-shaped metal wiring 3 is fixed to the fixing target 10 at multiple positions along the extending direction, the metal wiring 3 can be fixed to and routed on the fixing target 10 by selecting, out of the fixing members 100 and 100A to 100C, fixing members that are suitable for the fixing conditions at the respective positions.

A fixing portion is configured so as to have at least one of an anchor portion to be coupled to the fixing target 10, a through-hole, and a metal portion that can be welded.

In the case where the fixing member 100 or 100A is used, despite the fixing target 10 needing to have the hole 10a into which the anchor portion 102 or 102A acting as a coupling portion is to be inserted, it is possible to reduce the space required for the coupling on the inner side of a vehicle with respect to the fixing target 10. Also in this case, the metal wiring 3 can be fixed to and routed on the fixing target 10 by inserting the anchor portion 102 or 102A into the hole 10a of the fixing target 10, and this is advantageous in that there is little burden placed on a person performing the routing operation.

In the case where the fixing member 100B is used, despite the fixing target 10 needing to have the hole 10a into which the bolt 103B is to be inserted because the hole 102B functions as a coupling portion, it is possible to reduce the space required for the coupling on the outer side of a vehicle with respect to the fixing target 10. Also in this case, the metal wiring 3 can be fixed to and routed on the fixing target 10 by screwing the nut 104B onto the bolt 103B, and this is advantageous in that there is little burden placed on a person performing the routing operation.

In the case where the fixing member 100C is used, because the metal portion 102C functions as a coupling portion, there is no need to provide the hole 10a in the fixing target 10, and therefore it is possible to reduce the space required for the coupling on the inner side and the outer side of a vehicle with respect to the fixing target 10. However, in this case, the metal wiring 3 is fixed to and routed on the fixing target 10 through metal welding, and thus the burden on a person performing the routing operation may be greater as compared with the case where the fixing is performed using the fixing member 100, 100A, or 100B, which involves the insertion of the anchor portion 102 or 102A or the fastening between the bolt 103B and the nut 104B.

### Modified Examples

Although the above embodiment describes an example where the two conductor plates 31 and 32 are stacked to constitute the metal wiring 3, the metal wiring 3 may be constituted by a single conductor plate or may be constituted by stacking three or more conductor plates.

Although the above embodiment describes an example where the holes 101a and 201a are through-holes for allowing the belt portion 202 to pass therethrough, these holes may be holes into which at least the end portion 202b of the belt portion 202 is to be inserted.

Although the above embodiment describes an example where positioning of the fixing member 100 with respect to the holding member 200 in the Z-axis direction is performed by passing the band portion 202 through the holes 101a and 201a and by providing the latch mechanisms 204, the positioning of the fixing member 100 with respect to the holding member 200 in the Z-axis direction may be performed by either one of them.

The fixing members 100 and 100A to 100C described in the above embodiment are merely illustrative, and various other fixing members also can be used. For example, multiple fixing members that differ from each other in the shape of the anchor portion may be used. Also, in the configuration in which a bolt is inserted into a hole of a fixing member and the leading end of the bolt is fastened with a nut, multiple fixing members that differ from each other in the diameter of the hole may be used. In this case, a fixing member having a hole with a relatively large diameter may be used at a portion where tolerance is likely to occur in the vehicle body 4 and a fixing member having a hole with a relatively small diameter may be used at a portion where tolerance is unlikely to occur in the vehicle body 4.

The configurations described in the above-described embodiment and respective modified examples can be combined as appropriate unless mutual contradiction arises.

Although this fixing tool has been described in detail above, the above description is illustrative in all respects, and this fixing tool is by no means limited to the above description. It should be interpreted that a number of variations that are not described herein can be envisaged without departing from the scope of this fixing tool.

1. A fixing tool for fixing plate-shaped metal wiring to a fixing target in a vehicle in routing of the metal wiring, the fixing tool comprising:
a fixing member to be fixed to the fixing target; and
a holding member for holding the metal wiring, the holding member being provided separately from the fixing member,
wherein the holding member includes a mounting portion to which the fixing member is to be mounted and a band portion that is to be wrapped around and hold the metal wiring, and
the fixing member includes a fixing portion to be fixed to the fixing target and a portion to be mounted to the mounting portion.

2. The fixing tool according to claim 1,
wherein the band portion includes:
a base portion on which the metal wiring is to be placed;
a belt portion that extends from the base portion and has a free end on a side opposite to the base portion; and
a hole for fixing the free end of the belt portion, and
the base portion and the belt portion are wrapped around the metal wiring to hold the metal wiring.

3. The fixing tool according to claim 2,
wherein the fixing member has a fixing member side-hole that is in communication with the hole of the holding member.

4. The fixing tool according to claim 1, wherein the mounting portion includes:
a frame portion for guiding the fixing member so as to be mounted, and
a latch mechanism for restricting the mounting of the fixing member guided by the frame portion.

5. The fixing tool according to claim 1, wherein the fixing portion includes at least one of an anchor portion to be coupled to the fixing target, a through-hole, or a metal portion that can be welded.

6. The fixing tool according to claim 2, wherein the mounting portion includes:
a frame portion for guiding the fixing member so as to be mounted, and
a latch mechanism for restricting the mounting of the fixing member guided by the frame portion.

7. The fixing tool according to claim 3, wherein the mounting portion includes:
a frame portion for guiding the fixing member so as to be mounted, and
a latch mechanism for restricting the mounting of the fixing member guided by the frame portion.

8. The fixing tool according to claim 2, wherein the fixing portion includes at least one of an anchor portion to be coupled to the fixing target, a through-hole, or a metal portion that can be welded.

9. The fixing tool according to claim 3, wherein the fixing portion includes at least one of an anchor portion to be coupled to the fixing target, a through-hole, or a metal portion that can be welded.

10. The fixing tool according to claim 4, wherein the fixing portion includes at least one of an anchor portion to be coupled to the fixing target, a through-hole, or a metal portion that can be welded.
